(19) United States
(12) Patent Application Publication
(10) Pub. No.: US 2018/0349790 A1
(43) Pub. Date: Dec. 6, 2018

(54) Time-Based Features and Moving Windows Sampling For Machine Learning

(71) Applicant: Microsoft Technology Licensing, LLC, Redmond, WA (US)

(72) Inventors: Yaxiong CAI, Issaquah, WA (US); Xiaoguang QI, Bellevue, WA (US); Wei ZHUANG, Bellevue, WA (US); Shan YANG, Bellevue, WA (US); Vanessa MURDOCK, Kirkland, WA (US); Jayaram N.M. NANDURI, Issaquah, WA (US)

(21) Appl. No.: 15/609,648

(22) Filed: May 31, 2017

(51) Int. Cl. G06N 99/00

(52) U.S. Cl. CPC G06N 99/005

(57) ABSTRACT

A technique for training a machine learning model can use time-series data sampled from a population. The training includes creating a training set comprising feature vectors and corresponding labels generated using the time-series data. In some embodiments, for example, the feature vectors can include time-based features generated from the time-series data that preserves time information contained in the time-series data. The labels can be generated using data within a fixed period of time in the time-series data relative to a cut-off date. In some embodiments, the data used to create the training set can use a moving window sampling of the population to account for seasonal effects in the time-series data, where the cut-off date for generating the label varies from one sample to the next.

### BACKGROUND

Machine learning generally refers to techniques used for the discovery of patterns and relationships in sets of data to perform classification. Machine learning also refers to techniques using linear regression methods to perform forecasting. The goal of a machine learning algorithm is to discover meaningful or non-trivial relationships in a set of training data and produce a generalization of these relationships that can be used to interpret new, unseen data.

Supervised learning involves developing descriptions from a pre-classified set of training examples, where the classifications are assigned by an expert in the problem domain. The aim is to produce descriptions that will accurately classify unseen test examples. The basic flow of operations in supervised learning includes creating a set of training data (the training set) that is composed of pairs comprising a feature vector and a label (the training vectors). The training set is provided to a training module to modify/adapt parameters that define the machine learning model based on the training set. The adapted parameters of the machine learning model represent a generalization of the relationship between the pairs of feature vectors and labels in the training set.

### SUMMARY

Embodiments in accordance with the present disclosure include the creation of a training set (training data) to train machine learning models in order to predict or forecast outcomes in a population. The training set can be sampled from observations of the population, and can include time sequential events referred to as time-series data.

In accordance with aspects of the present disclosure, time-based features can be extracted from the time-series data based on subsets of the data that comprise the time-series data. The time-based features, therefore, can preserve time information contained in the time-series data. These time-based features can be included in the feature vectors of the training set. The training set can include labels that are also generated using data comprising the time-series data. However, unlike time-based features, labels do not preserve time information in the time-series data.

An aspect of the present disclosure considers seasonal influences in the time-series data. In some embodiments, feature extraction can include sampling observations from the population and using a sliding window to select different subsets of data to generate the feature vectors from the time-series data.

The following detailed description and accompanying drawings provide further understanding of the nature and advantages of the present disclosure.

### BRIEF DESCRIPTION OF THE DRAWINGS

With respect to the discussion to follow, and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The following discussion, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a simplified representation of an illustrative machine learning system in accordance with the present disclosure.

FIG. 2 is a simplified representation of observation data.

FIG. 3 represents examples of time-series data.

FIG. 4 is a simplified representation illustrating time-based features in accordance with the present disclosure.

FIG. 5 is a simplified representation of a computing system in accordance with the present disclosure

FIG. 6 is a high level flow of operations in a machine learning system in accordance with the present disclosure.

FIG. 7 is a high level flow of operations for generating a training set in accordance with the present disclosure.

FIG. 8 is a simplified representation illustrating time-based features in accordance with the present disclosure.

FIGS. 9A, 9B, 9C, and 9D illustrate a moving window aspect of the present disclosure.

### DETAILED DESCRIPTION

The present disclosure provides a supervised per-individual machine learning technique for forecasting. A machine learning technique in accordance with the present disclosure incorporates time-series information along with other features to train a machine learning model. More particularly, embodiments in accordance with the present disclosure are directed to machine learning techniques that can train from time-series data for individuals in a population in order to make forecasts on an individual in the population using previously observed and future observations of the individual.

Embodiments in accordance with the present disclosure can improve computer function by providing capability for time-series data that is not generally present in some predictive models, namely making forecasts based on subsets of data within the time-series data. Conventional time series models, for example, typically process time-series data by aggregating the time-series data. One type of time series model, for example, is based on a moving average. In this model, the time-series data is aggregated to produce a sequence of average values. Forecasting can be performed by identifying a trend in the sequence of computed average values, and extrapolating the trend. The aggregation of the time-series data (in this case, computation of the averages) results in the loss of timing information in the data. Time series models, therefore, generally cannot make forecasts based on when the events occurred, but rather on the entire history of observed events. For example, a moving average model developed from time-series data collected on a consumer's spend pattern over a period of time (e.g., two years) can make predictions based on that consumer's average spend over the entire two year period. The model cannot forecast spending during a particular time in the year (e.g., predict spending based on spending in the summer) because the process of computing the average spend data removes the time information component from the data.

A time series model typically represents only the individual for which the time-series data was collected. The moving average model, for example, computes averages for an individual and thus cannot be used to forecast outcomes for another individual because the time-series data for that other individual will be different; e.g., consider a stock market setting, a time series model for stock ABC would have no predictive power for stock XYZ.

Thus, time series modeling requires generating and updating a model instance for each individual, which can become impractical in very large populations in terms of computing power and storage requirements.

Some time series models are designed to aggregate across individuals, for example, summing the daily closing prices of stocks ABC and XYZ to produce a time-series composed of summed daily closing prices. The resulting model, however, represents the combined performances of stocks ABC and XYZ, not their individual performances.

As will become evident in the discussion below, embodiments in accordance with the present disclosure develop a single model, which can improve computer performance by reducing storage needs for modeling since only a single model serves to represent a sample of the population. By comparison, time series models require one model for each individual in the population; a population of millions would require storage for millions of time series models. In addition, embodiments in accordance with the present disclosure can improve computer processing performance because shorter processing time is needed to train a single model as compared to training a larger number (e.g., millions) of individual time series models.

Machine learning uses “features” of a population as training inputs to produce a “label” (reference output) that represents an outcome to arrive at a generalized representation between the features and the label, which can then be used to predict an outcome given new features. Features used for machine learning are typically static and not characterized by a time component such as in time-series data. Nonetheless, time-series data can be used for training a machine learning algorithm. For example, the time-series data can be aggregated to produce a value that represents a feature of the time-series data. Using the consumer example from above, the consumer's total spend over the entire observation period of the time-series data can represent a feature of that time-series data. However, as with time series models (e.g., moving average), the act of aggregating the time-series data in this way eliminates time information contained in the time-series data (e.g., the amount the consumer spent and when they spent it). Accordingly, conventional machine learning techniques cannot make forecasts based on particular patterns within the time-series data. As will become evident in the discussion below, embodiments in accordance with the present disclosure can improve computer performance by providing capability that is not generally present in conventional machine learning models, namely extracting time information from time-series data as time-based features for training machine learning models.

The use of time-based features improves machine learning when time-series data is involved. Machine learning algorithms that learn feature correlation can learn about temporal relationships among the time-based features for a given feature. Accordingly, the relationship between labels and time-based features can be learned. In addition, the relationship between labels and “intersections” between time-based features can be learned, which enables better machine learning accuracy. For example, suppose a time-based feature is the user's purchases of a given product in the last 2 days, and another time-based feature is the user's purchases of that produce in the last 7 days. Suppose further that the label is “user's future spending in the next 3 months.” Machine learning of these time-based features in accordance with the present disclosure allows for predictions or forecast of future spending for the next 3 months to based on spending the last 2 days, or based on spending in the last 7 days. In addition, if the machine learning algorithm handles feature correlation, then forecasts can be made based on the intersection of the 2-day and 7-day features, thus allowing for predictions or forecast of future spending to be based on spending in the last 2-7 days.

More generally, machine learning in accordance with the present disclosure can use any number of time-based features. Predictions or forecasts of future events (e.g., future spending) can be based on all the time-based features. Likewise, predictions/forecasts based on intersections between various combinations of the time-based features can be made when the machine learning algorithm has feature correlation capability.

Other advantages of machine learning training in accordance with embodiments of the present disclosure include greatly reducing the amount of data necessary to be transmitted, e.g., over a network, to the computer or computers of a server to train the predictive model on a large dataset. The amount of time required to re-train a previously trained predictive model, e.g., when a change in the input data has caused the model to perform unsatisfactorily, can be greatly reduced.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

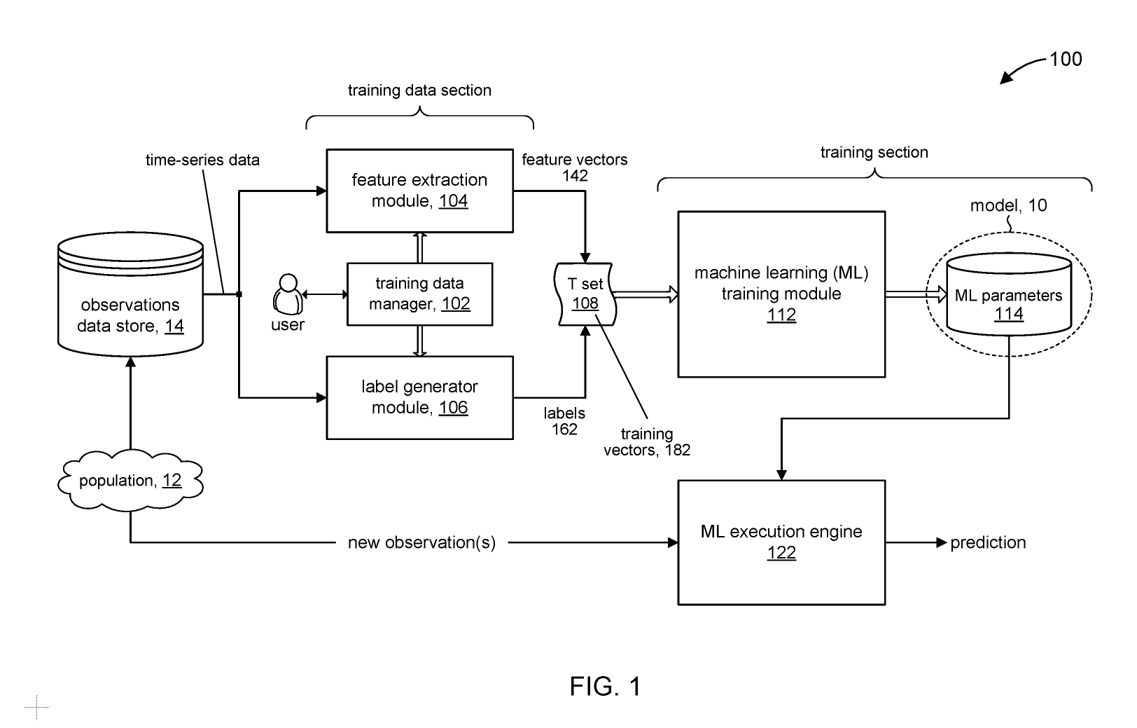

FIG. 1 shows a machine learning system 100 in accordance with various embodiments of the present disclosure. The machine learning system 100 supports a machine learning model or algorithm 10 that is configured to make predictions (forecast outcomes) among individuals in a population 12. Data collected from observations on individuals in population 12 and used to train the machine learning model 10 can be stored in an observations data store 14.

The observations data store 14 can store observed attributes of individuals in the population 12 collected over a period of time (observation period T). The observation period T can be defined from when the individual is placed in the population 12 to the current time. Some attributes may be static (i.e., generally do not change over time) and some attributes may be dynamic (i.e., vary over time).

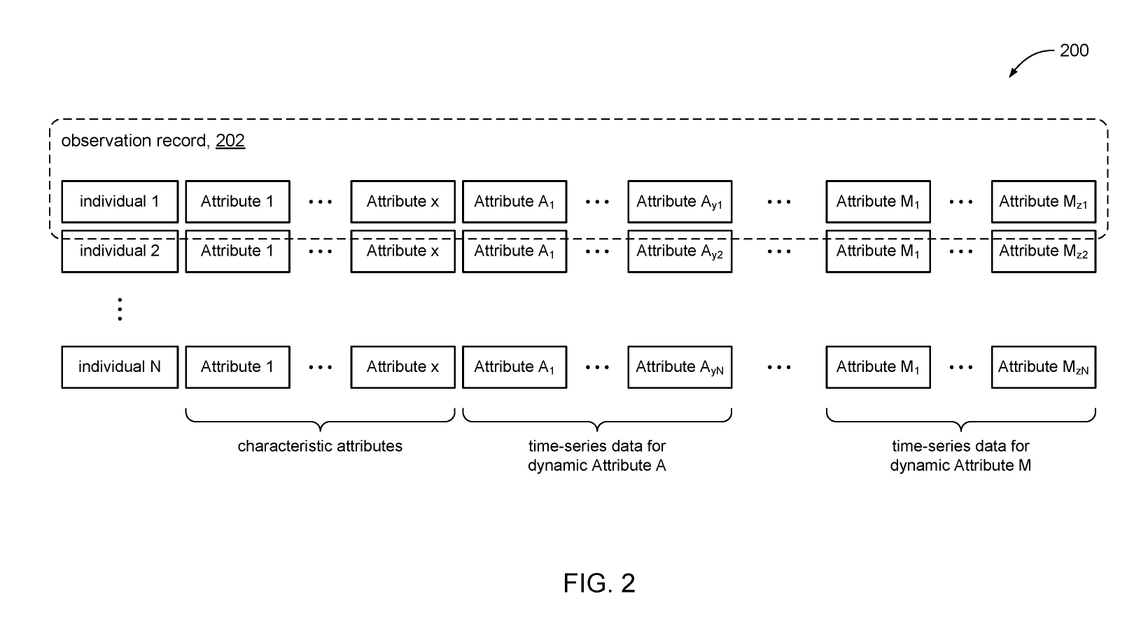

Referring to FIG. 2 for a moment, the figure shows a simplified representation of observations 200 that can be stored in the observational data store 14. Each individual in the population 12 can have a corresponding observation record 202 in the observations data store 14. Each observation record 202 can include a set of characteristic attributes (e.g., Attribute 1 . . . Attribute x) that characterizes the individual. Typically, these “characteristic attributes” are static in nature.

Each observation record 202 can also include data observed on attributes of the individual that have a time varying nature, referred to herein as “dynamic attributes.” For each dynamic attribute (e.g., Attribute A), the observation record 202 may include a set of time-series data (e.g., y1 events of Attribute A for individual 1: Attribute A₁ . . . Attribute A_{y1}) collected over the observation period T. Each time an event occurs (e.g., a purchase, a measurement is made, etc.) for an attribute, it can be added as another data point to the corresponding time-series data. The number of events in a given dynamic attribute can vary from one attribute to another, and can vary across individuals. For example, individual 1 has y1 events of Attribute A, individual 2 has y2 events of Attribute A, and so on. Events can be periodically collected in some cases, and in other cases can be aperiodic. Each event can be represented as a pair comprising the observed metric (e.g., customer spend amount, stock price, etc.) and the time of occurrence of the event.

The population 12 covers a wide range of possible domains. Some specific examples of populations and observations may be useful. For instance, population 12 may represent customers (individuals) of a retailer. The retailer may want to track the spend patterns of its population of customers. Accordingly, the observation record 202 for each customer may include characteristic attributes such as their city of residence, age range, occupation, type of car, hobbies, and the like; these attributes are generally constant and thus can be deemed to be static. Dynamic attributes may relate to a customer's spend patterns for different products/services over time. Each product/service, for example, can constitute an attribute; e.g., the spend pattern for a Product ABC may constitute one attribute, the spend pattern for Service XYZ may be another attribute, and so on. Each occurrence of a purchase defines an event (e.g., spend amount, time/date of purchase) that can added to the time-series data for that attribute for that individual.

As an example of another kind of population 12, consider a forest of trees; e.g., in an agricultural research setting. Researchers may want to track tree growth patterns under varying conditions such as soil treatments, fertilizers, ambient conditions, and so on. Each tree (individual) in the population of trees can be associated with an observation record 202 to record various attributes of that tree. Characteristic attributes can include type of tree, location of the tree, soil type that the tree is planted in, and so on. Dynamic attributes may include ambient temperature, amount of fertilizer applied, change in height of the tree, and so on.

As a final example of, consider the stock market. A stock trader would like to predict whether a stock price will go up or down at a given time, for example, the next business day. Population 12 can represent stocks. The stock trader may want to track each stock company's location, type, functionality, years since company established and so on. These can represent the characteristic attributes. Each stock in the stock market can be associated with an observation record 202 to record the stock price over a period of time, which represents a dynamic attribute.

Returning to FIG. 1, a machine learning system 100 in accordance with the present disclosure includes a training data section for generating training data used to train the machine learning model 10. The training data can be obtained from observations 200 collected on individuals comprising the population 12 and stored in the observations data store 14. In some embodiments, for example, the training data section can include a training data manager 102, a feature extraction module 104, and a label generator module 106.

The training data manager 102 generally manages the creation of the training set 108. In accordance with the present disclosure, the training data manager 102 can provide information to the feature extraction module 104 and the label generator module 106 to generate the data that comprises the training set 108. The training data manager 102 can receive input from a user having domain-specific knowledge to provide input to or otherwise interact with operations of the training data manager 102 to direct the creation of the training set 108.

The feature extraction module 104 can receive observation records 202 stored in the observations data store 14 and extract features from the observation records 202 to generate feature vectors 142 that comprise the training set 108. In accordance with the present disclosure, the feature extraction module 104 can generate a feature vector 142 comprising a set of time-based features generated from time-series data contained in an observation record 202 using time parameters provided by the training data manager 102. A set of time-based features can be generated for each attribute that is associated with time-series data. These aspects of the present disclosure are discussed in more detail below.

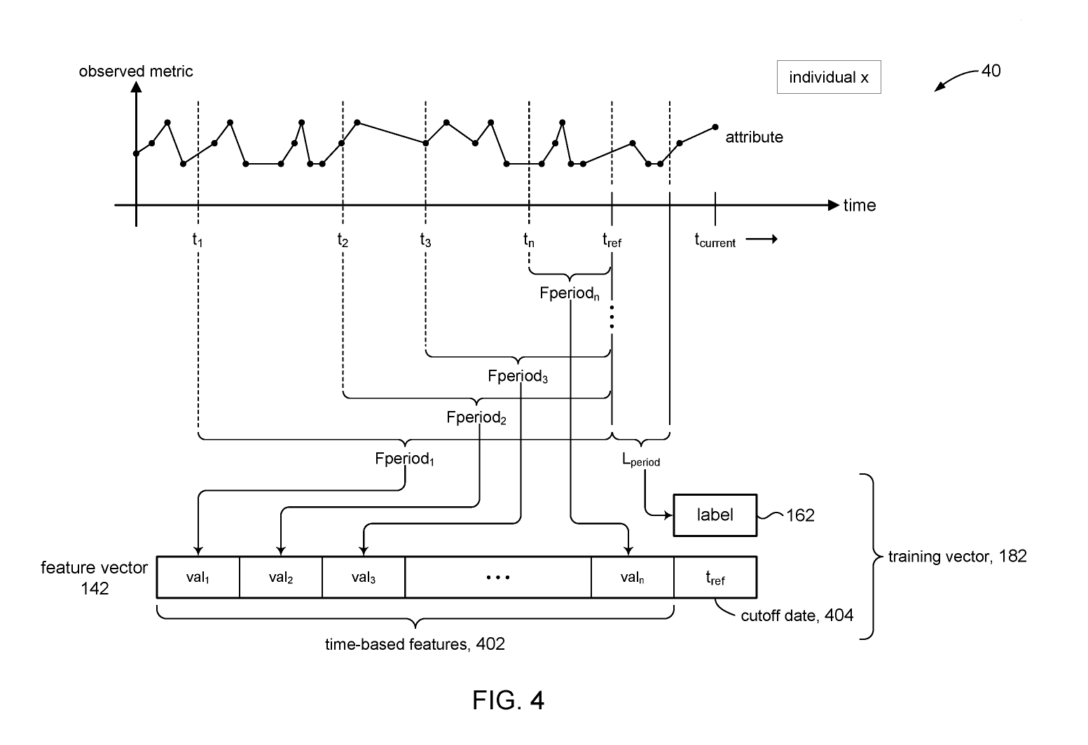

The label generator module 106 can generate labels 162 that comprise the training set 108. In accordance with the present disclosure, the label generator module 106 can produce labels 162 computed from data in the time-series data contained in the observation records 202. Aspects of the time-based features and the labels are discussed in more detail in FIG. 4 below.

The training set 108 comprises pairs (training vectors 182) that include a feature vector 142 and a label 162. The training set 108 can be provided to a training section in the machine learning system 100 to perform training of the machine learning model 10.

In some embodiments, the training section can include a machine learning training module 112 to train the machine learning model 10 and a data store 114 of parameters that define the machine learning model 10. This aspect of the present disclosure is well known and understood by persons of ordinary skill in the art. Generally, the machine learning training module 112 receives the training set 108 and iteratively tunes the parameters of the machine learning model 10 by running through the training vectors 182 that comprise the training set 108. The tuned parameters, which represent a trained machine learning model 10, can be stored in data store 114.

The machine learning system 100 includes an execution engine 122 to execute the trained machine learning model 10 to make a prediction (forecast) using newly observed events. The machine learning execution engine 122 can read in machine learning parameters from the data store 114 and execute the trained machine learning model 10 to process newly observed events and make a prediction or forecast of an outcome from the newly observed events.

The machine learning model 10 can use any suitable representation. In some embodiments, for example, the machine learning model 10 can be represented using linear regression models which represent the label as one or more functions of the features. Training performed by the machine learning training module 112 can use the training set 108 to adjust parameters of those functions to minimize some loss function. The adjusted parameters can be stored in the data store 114. In other embodiments, the machine learning model 10 can be represented using decision trees. In this case, the parameters define the machine learning model 10 as a set of decision trees that reduce the error as a result of applying the training set 108 to the machine learning training module 112.

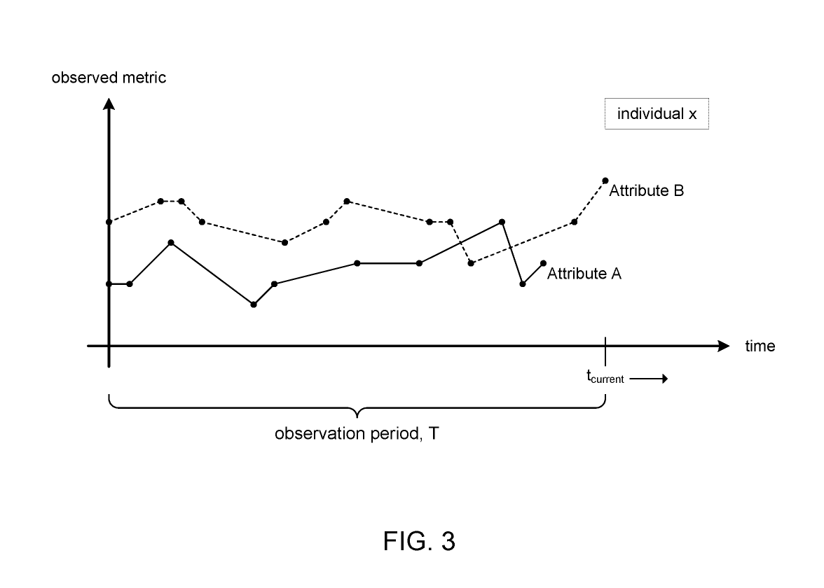

The discussion will now turn to a description of time-based features in accordance with the present disclosure. Time-based features are features extracted from time-series data made on individuals of population 12. FIG. 3 represents, in graphic form, examples of two dynamic attributes (Attribute A, Attribute B) for an individual (individual x) and their corresponding time-series data. If the population 12 represents customers of a retail store, then Attribute A may represent a customer's purchases of a product observed over the observation period T and Attribute B may represent the customer's purchases of another product. If the population 12 represents a population of trees, then Attribute A may represent, for an individual tree, the amount of fertilizer added to the soil over the observation period T and Attribute B may represent changes in height of that tree.

FIG. 4 illustrates an example of time-based features in accordance the present disclosure. The figure shows a feature vector 142 comprising a set of time-based features 402 and the corresponding time-series data 40 used to compute the time-based features 402. A time-based feature 402 is associated with a feature time period (e.g., Fperiod₁). Generally, a time-based feature 402 of the time-series data 40 can be generated based on a subset of the data that is specified by its associated feature time period. For example, the time-based feature val₁ is based on the subset of data in the time-series data 40 identified by the feature time period Fperiod₁. More particularly, val₁ can be generated by computing or otherwise aggregating data in the time-series 40 that were observed during the time period Fperiod₁. Likewise, the time-based feature val₂ can be generated by computing or otherwise aggregating data observed during its associated feature time period Fperiod₂, and so on with time-based features val₃ to valₙ. It can be seen that the time-based features 402 collectively preserve time information contained in the time-series data 40. For example, time-based feature val1 represents data in the time-series for time period Fperiod1, val2 represents data in the time-series for time period Fperiod2, and so on.

In accordance with the present disclosure, the feature time periods can be referenced relative to a reference time t_{ref}. For example, the feature time period Fperiod₁ refers to the period of time between t₁ and t_{ref}. The corresponding time-based feature val₁ is therefore based on data in the time-series 40 observed between t₁ and t_{ref}.

FIG. 4 further illustrates an example of a label 162 in accordance with the present disclosure. The figure shows that label 162 can be computed from the time-series data 40. Generally, the label 162 can be computed or otherwise generated from a single subset of the time-series data 40 specified by its associated label time period L_{period}. In particular, label 162 can be generated by computing or otherwise aggregating the data (e.g., computing a sum) in the time-series 40 that were observed during the time period L_{period}. In accordance with the present disclosure, the label time period L_{period} can be referenced relative to a reference time t_{ref}.

Unlike the time-based features 402, only one label 162 is computed from the time-series data 40. Accordingly, the label 162 does not relate to the time-series data 40 in the same way as the time-based features 402. Since only one value is computed, the label 162 does not preserve time information in the time-series data 40; for example, there is no relation among the data points in L_{period} used to compute label 162.

In accordance with the present disclosure, the feature time periods are periods of time earlier in time relative to t_{ref}, and the label time period is a period of time later in time relative to t_{ref}. The computed time-based features 402 in the feature vector 142 therefore represent past behavior and the computed label 162 represents a future behavior. The behavior is “future” in the sense that the time-series data used to compute the label 162 occurs later in time relative to the time-series data used to compute the time-based features 402.

FIG. 4 further illustrates that the reference time t_{ref} can be included in the feature vector 142 as a cutoff data feature 404. This aspect of the present disclosure is discussed below in connection with operational flows for creating a training set 108 in accordance with the present disclosure.

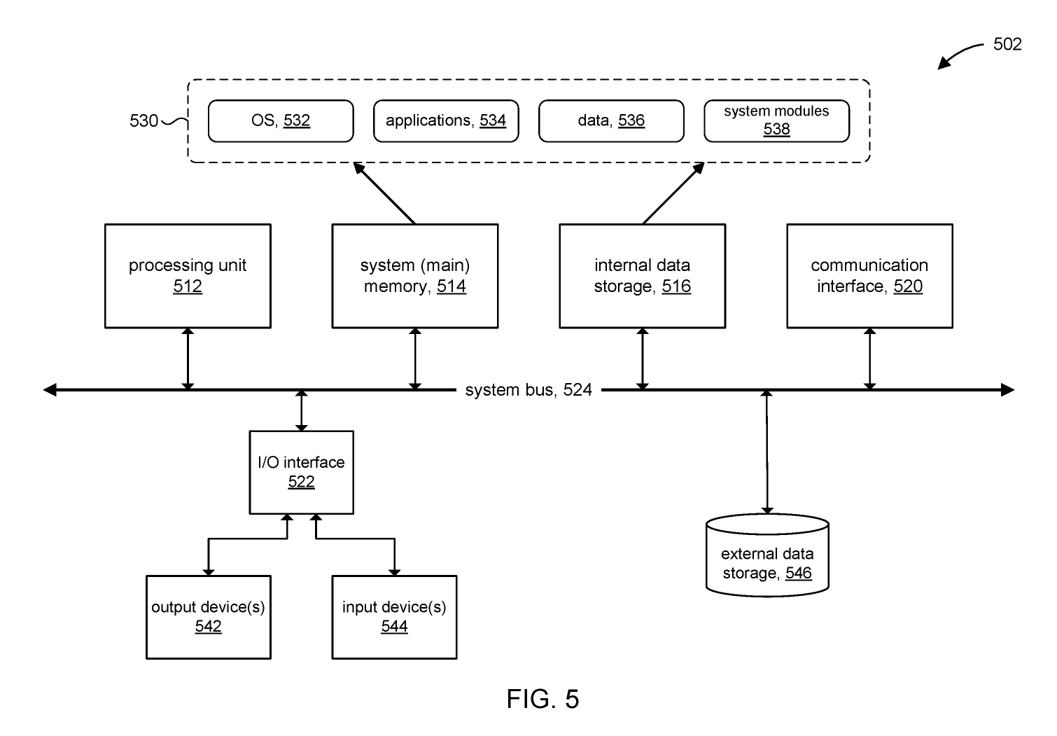

With reference to FIG. 5, the figure shows a simplified block diagram of an illustrative computing system 502 for implementing one or more of the embodiments described herein. For example, the computing system 502 may perform and/or be a means for performing, either alone or in combination with other elements, operations in the machine learning system 100 in accordance with the present disclosure. Computing system 502 may also perform and/or be a means for performing any other steps, methods, or processes described herein.

Computing system 502 can include any single or multi-processor computing device or system capable of executing computer-readable instructions. Examples of computing system 502 include, for example, workstations, laptops, client-side terminals, servers, distributed computing systems, handheld devices, or any other computing system or device. In a basic configuration, computing system 502 can include at least one processing unit 512 and a system (main) memory 514.

Processing unit 512 can comprise any type or form of processing unit capable of processing data or interpreting and executing instructions. The processing unit 512 can be a single processor configuration in some embodiments, and in other embodiments can be a multi-processor architecture comprising one or more computer processors. In some embodiments, processing unit 512 may receive instructions from program and data modules 530. These instructions can cause processing unit 512 to perform operations in accordance with the present disclosure.

System memory 514 (sometimes referred to as main memory) can be any type or form of volatile or non-volatile storage device or medium capable of storing data and/or other computer-readable instructions. Examples of system memory 514 include, for example, random access memory (RAM), read only memory (ROM), flash memory, or any other suitable memory device. Although not required, in some embodiments computing system 502 may include both a volatile memory unit (such as, for example, system memory 514) and a non-volatile storage device (e.g., data storage 516, 546).

In some embodiments, computing system 502 may also include one or more components or elements in addition to processing unit 512 and system memory 514. For example, as illustrated in FIG. 5, computing system 502 may include internal data storage 516, a communication interface 520, and an I/O interface 522 interconnected via a system bus 524. System bus 524 can include any type or form of infrastructure capable of facilitating communication between one or more components comprising computing system 502. Examples of system bus 524 include, for example, a communication bus (such as an ISA, PCI, PCIe, or similar bus) and a network.

Internal data storage 516 may comprise non-transitory computer-readable storage media to provide nonvolatile storage of data, data structures, computer-executable instructions, and so forth to operate computing system 502 in accordance with the present disclosure. For instance, the internal data storage 516 may store various program and data modules 530, including for example, operating system 532, one or more application programs 534, program data 536, and other program/system modules 538. In some embodiments, for example, the internal data storage 516 can store one or more of the training data manager module 102 (FIG. 1), feature extraction module 104, label generator module 106, machine learning training module 112, and machine learning execution engine 122 shown in FIG. 1, which can then be loaded into system memory 514. In some embodiments, internal data storage 516 can serve as the data store 114 of machine learning parameters.

Communication interface 520 can include any type or form of communication device or adapter capable of facilitating communication between computing system 502 and one or more additional devices. For example, in some embodiments communication interface 520 may facilitate communication between computing system 502 and a private or public network including additional computing systems. Examples of communication interface 520 include, for example, a wired network interface (such as a network interface card), a wireless network interface (such as a wireless network interface card), a modem, and any other suitable interface.

In some embodiments, communication interface 520 may also represent a host adapter configured to facilitate communication between computing system 502 and one or more additional network or storage devices via an external bus or communications channel. Examples of host adapters include, for example, SCSI host adapters, USB host adapters, IEEE 1394 host adapters, SATA and eSATA host adapters, ATA and PATA host adapters, Fibre Channel interface adapters, Ethernet adapters, or the like.

Computing system 502 may also include at least one output device 542 (e.g., a display) coupled to system bus 524 via I/O interface 522. The output device 542 can include any type or form of device capable of visual and/or audio presentation of information received from I/O interface 522.

Computing system 502 may also include at least one input device 544 coupled to system bus 524 via I/O interface 522. Input device 544 can include any type or form of input device capable of providing input, either computer or human generated, to computing system 502. Examples of input device 544 include, for example, a keyboard, a pointing device, a speech recognition device, or any other input device.

Computing system 502 may also include external data storage 546 coupled to system bus 524. External data storage 546 can be any type or form of storage device or medium capable of storing data and/or other computer-readable instructions. For example, external data storage 546 may be a magnetic disk drive (e.g., a so-called hard drive), a solid state drive, a floppy disk drive, a magnetic tape drive, an optical disk drive, a flash drive, or the like. In some embodiments, external data storage 546 can serve as the observations data store 14.

In some embodiments, external data storage 546 may comprise a removable storage unit to store computer software, data, or other computer-readable information. Examples of suitable removable storage units include, for example, a floppy disk, a magnetic tape, an optical disk, a flash memory device, or the like. External data storage 546 may also include other similar structures or devices for allowing computer software, data, or other computer-readable instructions to be loaded into computing system 502. External data storage 546 may also be a part of computing system 502 or may be a separate device accessed through other interface systems.

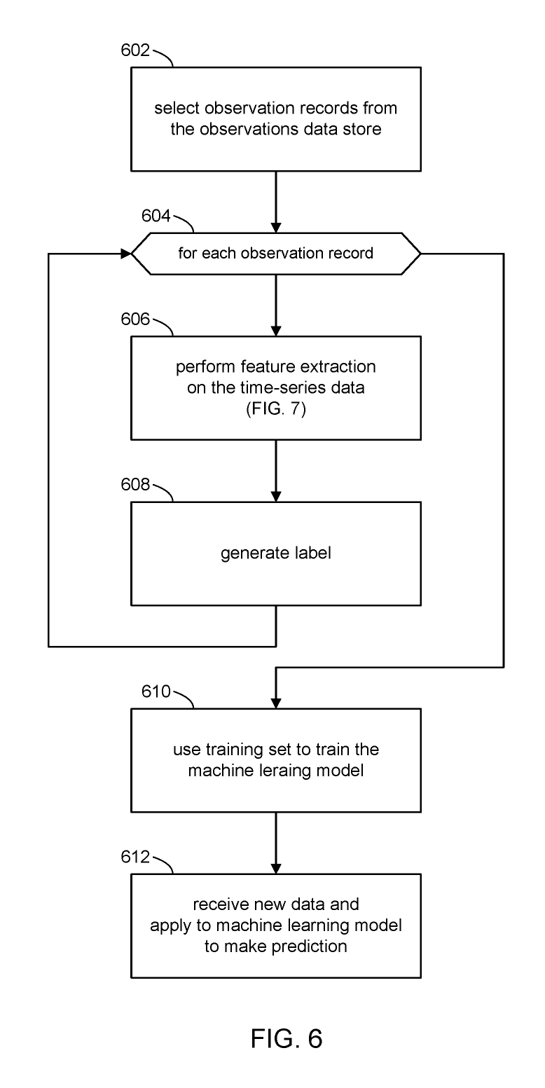

Referring to FIG. 6 and previous figures, the discussion will now turn to a high level description of processing in the machine learning system 100 in accordance with the present disclosure. In some embodiments, for example, the machine learning system 100 may comprise computer executable program code, which when executed by a computer system (e.g., 502, FIG. 5), can cause the computer system to perform the flow of operations shown FIG. 6. The flow of operations performed by the computer system is not necessarily limited to the order of operations shown.

At block 602, the machine learning system 100 can select observation records 202 from the observations data store 14 for the training set 108. In some embodiments, for example, the training data manager 102 can select observation records 202 from the observations data store 14 and provide them to both the feature extraction module 104 and the label generator module 106. In some embodiments, the training set 108 may be generated from the entire observations data store 14. In other embodiments, the training data manager 102 can randomly sample observation records 202 from the observations data store 14.

In accordance with the present disclosure, the training data manager 102 can provide time parameters to the feature extraction module 104 and label generator module 106, in addition to the observation records 202. Time parameters for the feature extraction module 104 can include the reference time t_{ref} (FIG. 4) and a set of feature time periods (e.g., Fperiod₁, Fperiod₂, etc.) for computing each time-based feature 402. Time parameters for the label generator module 106 can include the reference time t_{ref} and the label time period L_{period}.

The time parameters can be specified by a user who has domain-specific knowledge of the population 12 so that the time parameters are meaningful within the context of the domain of the population 12. In the case where observation records 202 comprise multiple dynamic attributes, and hence multiple sets of time-series data, each set of time-series data can have a corresponding set of time parameters specific to that set of time-series data.

At block 604, for each observation record 202, the machine learning system 100 can perform the following:

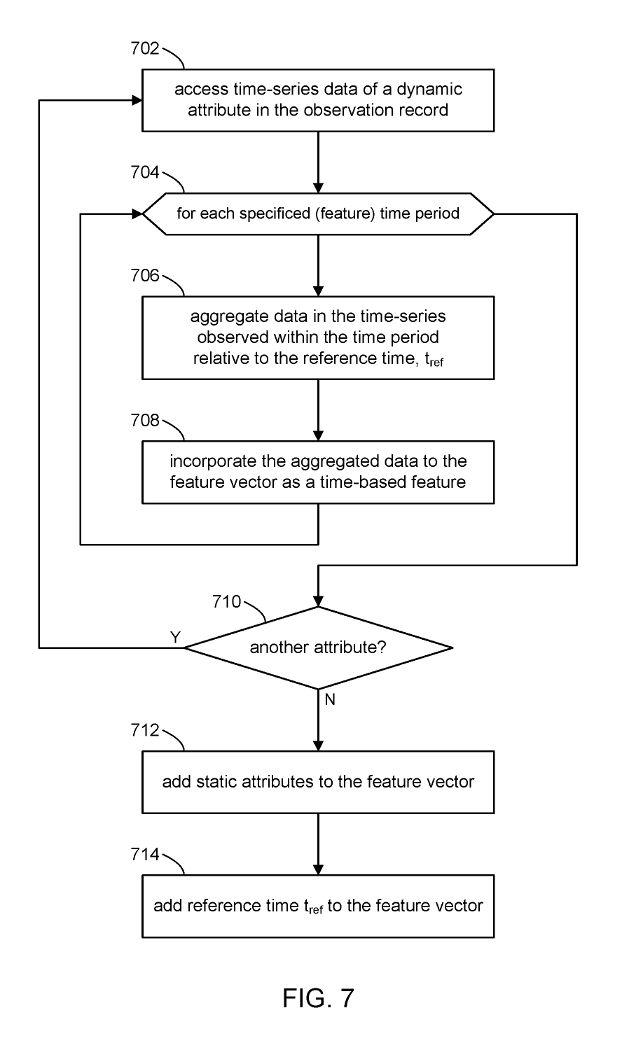

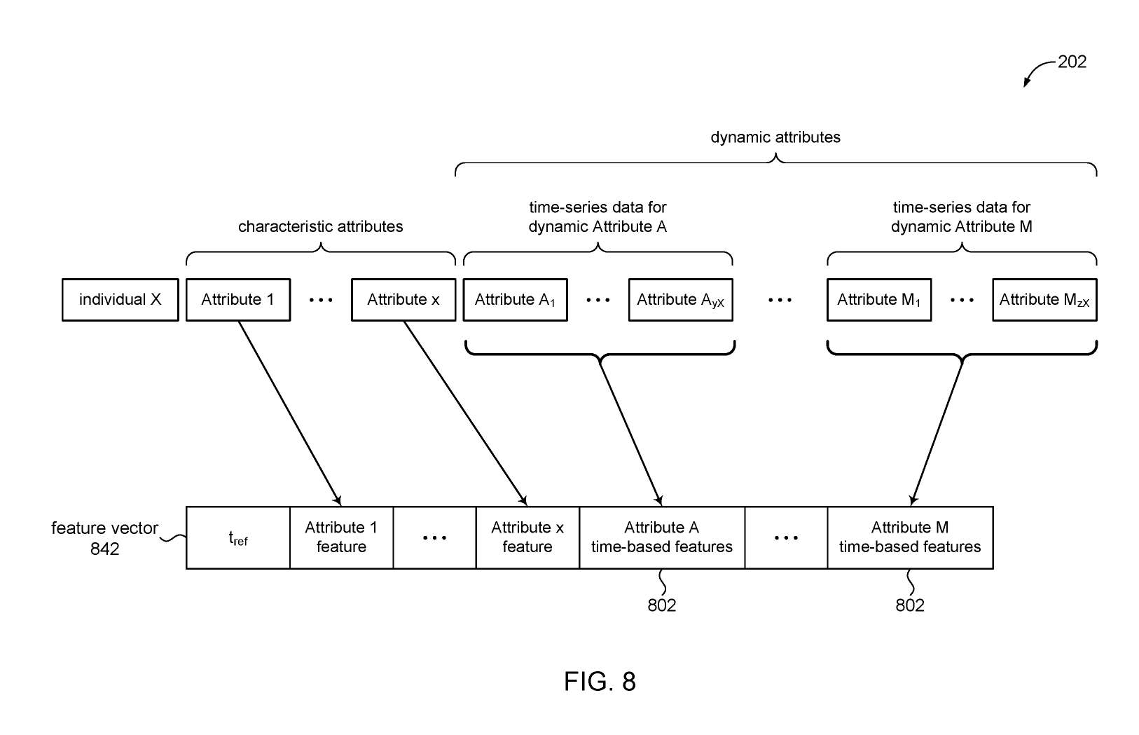

At block 606, the machine learning system 100 can perform feature extraction on each observation record 202 provided by the training data manager 102 to generate a feature vector 142. In some embodiments, for example, the feature extraction module 104 can extract time-based features for each set of time-series data contained in the received observation record 202 to build the feature vector 142. This aspect of the present disclosure is discussed in FIGS. 7 and 8 described below.

At block 608, the machine learning system 100 can generate a label 162 from each observation record 202 provided by the training data manager 102. In some embodiments, for example, the label generator module 106 can use the reference time t_{ref} and the label time period L_{period} provided by the training data manager 102 to access the subset of data in the time-series data for computing the label 162.

In some embodiments, the label 162 may be computed from time-series data for just one of the dynamic attributes in the observation record 202; e.g., the training data manager 102 can identify the attribute, using information provided by the domain-knowledgeable user. For instance, using the above example of an agricultural research setting, suppose a researcher is interested on the various factors that affect tree growth. The feature vector may comprise features computed from several attributes such as types of tree, location of the trees, soil types, etc. The label 162, however, may be based only on the one attribute for change in tree height.

On the other hand, in other embodiments, the label 162 may be computed by aggregating several attributes. In the retailer example, where the population 12 consists of the retailer's customers, the retailer may be interested in forecasting a customer's total purchases. In this case, the label 162 can represent a total spend that can be computed by aggregating the time-series data from several attributes, where each attribute is associated with a product/service of the retailer. For example, the label time period L_{period} (e.g., 3 month period) and reference time t_{ref} (e.g., June) can be used to identify a customer's purchase amounts for the 3 month period starting from June for every product, which can then be summed to produce a single grand total spend amount for that customer.

The resulting feature vector (block 606) and the label (block 608) define one training vector 182 of the training set. Processing can return to block 604 to repeat the process for each of the sampled observation records 202 (block 602) to generate additional training vectors 182 that comprise the training set 108.

At block 610, the machine learning system 100 can use the training set 108 to train the machine learning model 10. In some embodiments, for example, the machine learning training module 112 can input training vectors 182 from the training set 108 to train the machine learning model 10. Machine learning training techniques are known by persons of ordinary skill in the machine learning arts. It is understood that the training details for training a machine learning model can differ widely from one machine learning algorithm to the next. However, the following brief description is given merely for the purpose of providing an illustrative example of the training process.

Suppose the machine learning model 10 is based on a Gradient Boosted Decision Tree algorithm. For each, training vector 182 in the training set 108, machine learning training module 112 can apply a subset of the feature vector 142 in the training vector 182 to the machine learning model 10 to produce an output. The machine learning training module 112 can adapt the decision tree using an error that represents a difference between the produced output and the label 162 contained in the training vector 182. The machine learning training module 112 can create a new tree to predict the error, and record the new tree's output as an error for the next iteration. The process is iterated with each training vector 182 in the training set 108 to produce another new tree, until all the training vectors 182 have been consumed. The initial tree and the subsequently created new trees (which provide successions of error correction) can be aggregated and stored in data store 114 as a trained machine learning model 10.

At block 612, the machine learning system 100 can then use the trained machine learning model 10 to make predictions on newly observed events.

Referring to FIG. 7 and previous figures, the discussion will now turn to a high level description of processing in the feature extraction module 104 for generating feature vectors 142 in accordance with the present disclosure. In some embodiments, for example, the feature extraction module 104 may comprise computer executable program code, which when executed by a computer system (e.g., 502, FIG. 5), can cause the computer system to perform the processing in accordance with FIG. 7. The flow of operations performed by the computer system is not necessarily limited to the order of operations shown.

At block 702, the feature extraction module 104 can obtain an observation record 202 specified by the training data manager 102 and access the time-series data for a dynamic attribute contained in the observation record 202.

At block 704, the feature extraction module 104 can use time parameters specified by the training data manager 102 that are associated with the time-series data accessed in block 702. The time parameters can include the reference time t_{ref} and the feature time periods (e.g., Fperiod₁, Fperiod₂, etc., FIG. 4). For each feature time period, the feature extraction module 104 can perform the following:

At block 706, the feature extraction module 104 can use t_{ref} and the feature time period (e.g., Fperiod₁) to identify the data in the time-series data to be aggregated. Referring to FIG. 4, for example, t_{ref} and Fperiod₁ identify the subset of data in the time-series data 40 to be aggregated. The aggregation operation can be any suitable computation; e.g., summation, average, etc. The aggregated value (e.g., val₁) characterizes the time-series data 40 and thus can serve as a feature of the time-series data 40. Since the aggregated value is computed using data from a specific period of time within the time-series data 40, the aggregated value is referred to as a “time-based” feature of the time-series data 40. The feature val₁, therefore characterizes the time-series data 40 at a specific period of time within the observation period T of the time-series data 40.

At block 708, the feature extraction module 104 can add the aggregated value of the feature (e.g., val₁) to the feature vector 142. Processing can return to block 704 to repeat the process with the next feature time period (e.g., Fperiod₂), and so on until all the feature time periods corresponding the attribute accessed in block 702 are processed.

At block 710, if the received observation record 202 (block 702) includes another dynamic attribute, then the feature extraction module 104 can return to block 702 to process its corresponding time-series data, thus adding time-based features from this additional attribute to the feature vector 142.

At block 712, after all dynamic attributes have been processed, the feature extraction module 104 can add static attributes as features to the feature vector 142.

At block 714, the feature extraction module 104 can add the reference time t_{ref} as a feature to the feature vector 142. This aspect of the present disclosure is discussed in more detail below.

FIG. 8 illustrates an example of a feature vector 842 generated in accordance with the present disclosure from an observation record 202. The feature vector 842 can comprise one or more sets of time-based features 802 generated from the time-series data of one or more corresponding dynamic attributes in the observation record 202. The feature vector 842 can also include the static attributes from the observation record 202.

The resulting training set 108 that results from the foregoing operations illustrated in FIGS. 6-8 represents observations sampled from among the individuals that comprise population 12. The machine learning model 10 can therefore be trained based on individual behavior. The resulting trained machine learning model 10 can make predictions/forecasts for an individual based on newly observed events collected for that individual because the machine learning model 10 was trained using a training set 108 based on individual observations rather than aggregations of the observations, thus preserving the individuality of the observations.

In accordance with the present disclosure, the training set 108 preserves time information in the time-series data by extracting features from the time-series data that represent different periods of time in the time-series, for example, as shown in FIG. 4 and explained in FIG. 7. In particular, the reference time t_{ref} establishes “previous” data in the time-series data that is used to generate the feature vector 142 (time-based features 402) and “future” data that is used to generate the label 162. Accordingly, this allows the machine learning model 10 to model individuals' past and future behavior. The resulting trained machine learning model 10 can make predictions/forecasts for an individual based on new time-series data collected for that individual.

Time-series data can have seasonal influences. For example, customers of a clothing retailer will exhibit different purchasing patterns (e.g. what clothes they buy, how much they spend, etc.) during different times of the year. In the agricultural research example, tree growth patterns can vary during different times of the year, and those growth patterns can change depending on factors such as time of year, when fertilizers are used during the year, and so on. Generally, the term “seasonal” does not necessarily refer to seasons of the year, but rather to influences that have a periodic nature over the span of the observation period T that can affect the behavior of the population 12. In accordance with the present disclosure, the reference time t_{ref} can vary with each sampled observation record 202 to provide a moving or sliding window for computing the label 162 to account for the effects of “when” the events in the time-series data occur.

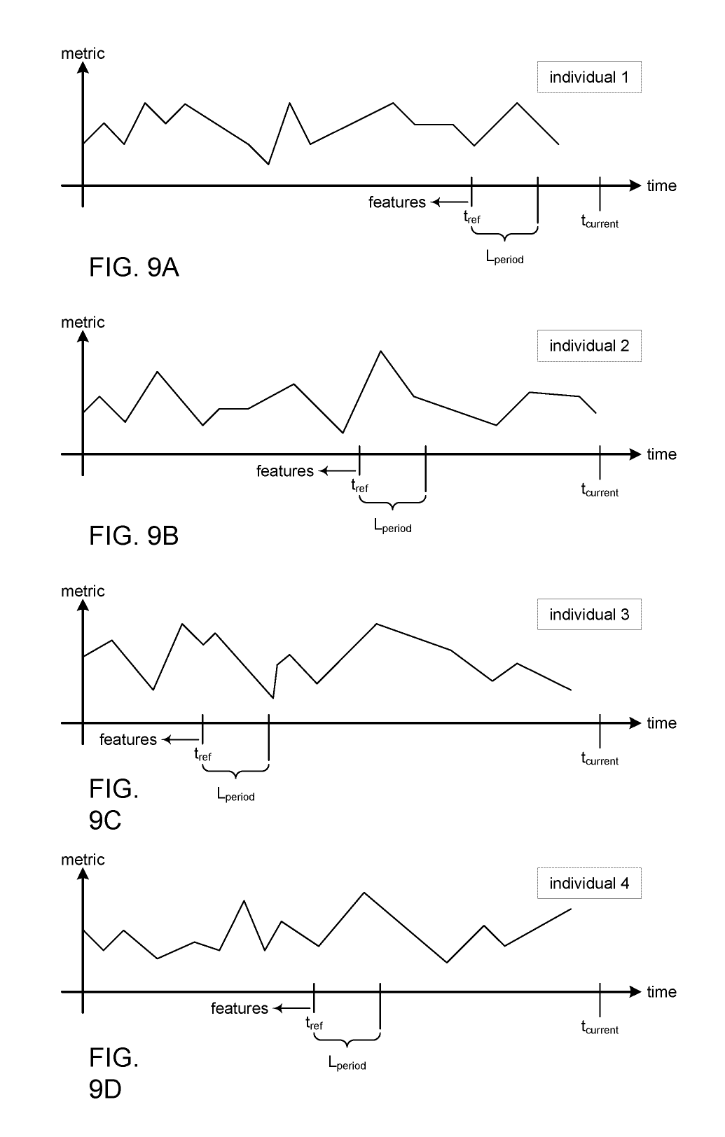

FIGS. 9A-9D illustrate a moving window for computing the label 162 in accordance with the present disclosure, and its effect on computing the time-based features for feature vector 142. FIG. 9A shows an initial setting of the time reference t_{ref} for a given observation record 202. The label time period L_{period} defines a window of the time-series data used to compute the label 162. The time reference t_{ref} also sets a cutoff date for computing the time-based features. As noted above in FIG. 7, the time reference t_{ref} can be incorporated as a feature (the cutoff date) in the feature vectors 142.

FIG. 9B shows the time t_{ref} is shifted to another time for another observation record 202. For example, the training data manager 102 can vary t_{ref} with each observation record 202. The label time period L_{period} shifts as well, thus moving the window of data used to compute the label for the training vector 182 created from the observation record 202. It is noted that the span of time for computing the feature vectors 142 also varies with t_{ref}. The number of computed time-based features for the training vector 182 can therefore vary from one observation record 202 to another.

In some embodiments, the training data manager 102 can monotonically adjust t_{ref} relative to the current time t_{current} with each observation record 202. FIGS. 9A-9C illustrate this sequence. Sliding the value of t_{ref} in this way can ensure the entire observation period T is covered. In other embodiments, the training data manager 102 can randomly select the value for t_{ref} with each observation record 202. This random selection is illustrated by the sequence of FIGS. 9A-9D.

The moving window incorporates feature vectors 142 and labels 162 that are computed at different times within the observation period T of a time-series. This allows for the machine learning model 10 to represent the population at different times within the observation period T. In applications where the observation period T is on the order of many years, the moving window sampling can be used to represent the population at different seasons during the year, on special occasions (e.g., national holidays, religious events, etc.) that occur during the year, and so on. Accordingly, this allows the machine learning model 10 to model individuals' behavior at specific times during the observation period T. The resulting trained machine learning model 10 can make predictions/forecasts for an individual based on new time-series data collected for that individual. In particular the prediction/forecast can take into account the timing of when those newly observed events were made.

Consider the reference time t_{ref} in FIG. 9A, for example. The reference time t_{ref} may be set at a time during the winter season. Accordingly, the computed feature vector 142 and label 162 would represent an example of behavior in the winter. The reference time t_{ref} in FIG. 9B can be a time in the fall season, and the computed feature vector 142 and label 162 would represent an example of behavior in the fall. Similarly, the reference time t_{ref} in FIG. 9C can be a time in the summer, and the computed feature vector 142 and label 162 would represent an example of behavior in the summer. By varying the reference time t_{ref} in this manner for every observation record 202, the machine learning model 10 can represent the population at different times of the year.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method comprising:
receiving, by a computing device, time-series data associated with an individual in a population of individuals;
generating, by the computing device, a feature vector using the time-series data by computing a plurality of time-based features using subsets of data in the time-series data specified by a plurality of feature time periods that correspond to the plurality of time-based features;
generating, by the computing device, a label by computing a value using a subset of data in the time-series data specified by a label time period, wherein the feature vector and the label define a training vector;
creating, by the computing device, a training set comprising a plurality of training vectors by repeating the foregoing operations using time-series data associated with additional individuals in the population, each training vector in the training set comprising a feature vector and a label generated using the time-series data associated with one of the additional individuals;
providing, by the computing device, the training set to a machine learning model to train the machine learning model; and
forecasting an attribute represented by the time-series data for any individual in the population of individuals using the trained machine learning model.

2. The method of claim 1, wherein each time-based feature is an aggregation of data in the time-series data of events occurring in the feature time period that corresponds to the time-based feature.

3. The method of claim 1, wherein the plurality of feature time periods and the label time period are referenced relative to a reference time t_{ref}.

4. The method of claim 3, wherein each feature time period occurs prior in time to the reference time t_{ref}, wherein the label time period occurs subsequent in time to the reference time t_{ref}.

5. The method of claim 1, wherein the plurality of feature time periods and the label time period are referenced relative to a reference time t_{ref} that differs from one training vector to another.

6. The method of claim 5, further comprising including, by the computing device, the reference time t_{ref} as a feature in the feature vector.

7. The method of claim 5, further comprising, for each training vector, randomly selecting, by the computing device, a value of the reference time t_{ref}.

8. The method of claim 5, further comprising the computing device:
selecting an initial value of the reference time t_{ref} for a first training vector; and
monotonically incrementing the reference time t_{ref} for each subsequent training vector.

9. The method of claim 1, further comprising randomly selecting, by the computing device, a sample of individuals from the population and creating the training set from the sampled individuals.

10. A non-transitory computer-readable storage medium having stored thereon computer executable instructions, which when executed by a processing unit, cause the processing unit to:
receive time-series data associated with an individual in a population of individuals;
generate a feature vector using the time-series data by computing a plurality of time-based features using subsets of data in the time-series data specified by a plurality of feature time periods that correspond to the plurality of time-based features;
generate a label by computing a value using a subset of data in the time-series data specified by a label time period, wherein the feature vector and the label define a training vector;
create a training set comprising a plurality of training vectors by repeating the foregoing operations using time-series data associated with additional individuals in the population, each training vector in the training set comprising a feature vector and a label generated using the time-series data associated with one of the additional individuals;
provide the training set to a machine learning model to train the machine learning model; and
forecast an attribute represented by the time-series data for any individual in the population of individuals using the trained machine learning model.

11. The computer-readable storage medium of claim 10, wherein each time-based feature is an aggregation of data in the time-series data of events occurring in the feature time period that corresponds to the time-based feature.

12. The computer-readable storage medium of claim 10, wherein the plurality of feature time periods and the label time period are referenced relative to a reference time t_{ref}.

13. The computer-readable storage medium of claim 12, wherein each feature time period occurs prior in time to the reference time t_{ref}, wherein the label time period occurs subsequent in time to the reference time t_{ref}.

14. The computer-readable storage medium of claim 10, wherein the plurality of feature time periods and the label time period are referenced relative to a reference time t_{ref} that differs from one training vector to another.

15. The computer-readable storage medium of claim 14, wherein the computer executable instructions, which when executed by the processing unit, further cause the processing unit to include the reference time t_{ref} as a feature in the feature vector.

16. An apparatus comprising:
one or more computer processors; and
a computer-readable storage medium comprising instructions for controlling the one or more computer processors to be operable to:
receive time-series data associated with an individual in a population of individuals;
generate a feature vector using the time-series data by computing a plurality of time-based features using subsets of data in the time-series data specified by a plurality of feature time periods that correspond to the plurality of time-based features;
generate a label by computing a value using a subset of data in the time-series data specified by a label time period, wherein the feature vector and the label define a training vector;
create a training set comprising a plurality of training vectors by repeating the foregoing operations using time-series data associated with additional individuals in the population, each training vector in the training set comprising a feature vector and a label generated using the time-series data associated with one of the additional individuals;
provide the training set to a machine learning model to train the machine learning model; and
forecast an attribute represented by the time-series data for any individual in the population of individuals using the trained machine learning model.

17. The apparatus of claim 16, wherein each time-based feature is an aggregation of data in the time-series data of events occurring in the feature time period that corresponds to the time-based feature.

18. The apparatus of claim 16, wherein the plurality of feature time periods and the label time period are referenced relative to a reference time t_{ref} that differs from one training vector to another.

19. The apparatus of claim 18, wherein the computer-readable storage medium further comprises instructions for controlling the one or more computer processors to be operable to randomly select, for each training vector, a value of the reference time t_{ref}.

20. The apparatus of claim 18, wherein the computer-readable storage medium further comprises instructions for controlling the one or more computer processors to be operable to include the reference time t_{ref} as a feature in the feature vector.
